(19) United States
(12) Patent Application Publication
(10) Pub. No.: US 2013/0313044 A1
(43) Pub. Date: Nov. 28, 2013

(54) EXTENSION BOOM APPARATUS

(71) Applicant: J. Aubrey Stewart, Westville (CA)

(72) Inventor: J. Aubrey Stewart, Westville (CA)

(21) Appl. No.: 13/901,943

(22) Filed: May 24, 2013

Related U.S. Application Data
(60) Provisional application No. 61/651,707, filed on May 25, 2012.

(51) Int. Cl. B66F 11/04

(52) U.S. Cl. CPC B66F 11/046
USPC 182/63.1

(57) ABSTRACT

An extension boom apparatus provides a pair of orthogonally connected extension booms and a distal mounted personnel basket adapted for leveraged connection to an excavator.

### CROSS-REFERENCE TO RELATED APPLICATIONS

This application claims priority to U.S. Provisional Application No. 61/651,707 filed May 25, 2012 and entitled EXTENSION BOOM APPARATUS, the entire contents of which are incorporated herein by reference for all purposes.

### FIELD OF THE INVENTION

The present invention generally relates to boom trucks used for large construction, and in particular to an attachment boom apparatus for reaching under a bridge or support structure.

### BACKGROUND OF THE INVENTION

The aging of infrastructure is a well known problem with critical emphasis on bridge structures and the like due to their life threatening potential as well as common location at critical intersections. Inspection practices of bridge structures play a critical role in problems detection and the avoidance of critical failures, Unfortunately, the ease of inspection is limited by access to the underside of bridge structures, which can require the construction of scaffolding and other cumbersome procedures. Bridge structures are also a common location for utilities, which can further interfere with inspection access to their respective bridge structures and the maintenance of which could also benefit from more convenient access.

In view of the above discussion, it would be beneficial to provide an apparatus for more conveniently accessing the underside of bridge structures and the like.

### SUMMARY OF THE INVENTION

One embodiment of the present invention provides an extension boom apparatus for an excavator, comprising a first extension boom adapted for vertical orientation, a second extension boom adapted for horizontal orientation, a leveraged excavator coupling affixed to a proximal end of the first extension boom, an orthogonal attachment between a distal end of the first extension boom and a proximal end of the second extension boom, and a personnel basket coupled to a distal end of the second extension boom.

The apparatus may further comprise a rotational joint connecting the second extension boom to the orthogonal attachment and oriented to provide rotation of the second extension boom in a radial plane of rotation of the first extension boom. The apparatus may further comprise a mechanism for controlling rotation of the second extension boom in a radial plane of rotation of the first extension boom.

The apparatus may further comprise a rotational coupling between the second extension boom and the personnel basket, oriented to enable rotation of the personnel basket in a vertical axial plane of the second extension. The apparatus may further comprise an actuator for controlling the angular orientation between the personnel basket and the second extensional boom.

### BRIEF DESCRIPTION OF THE DRAWINGS

The present invention is illustratively shown and described in reference to the accompanying drawings, in which:

FIG. 1 shows a partially sectioned side view of one embodiment of an extension boom apparatus constructed in accordance with an embodiment of the present invention and attached to an excavator as it would be used for accessing under a bridge structure;

FIG. 2 is a perspective view of the extension boom apparatus of FIG. 1;

FIG. 3 is an enlarged side view of the extension boom apparatus of FIGS. 1 and 2; and

FIG. 4 is a top view of the extension boom apparatus of FIGS. 1-3.

### DETAILED DESCRIPTION OF THE DRAWINGS

The present invention is introduced using examples and particular embodiments for descriptive purposes. Although a variety of examples are presented to show how various configurations can be employed to achieve the desired improvements, these particular embodiments are only illustrative and not intended in any way to restrict the inventions presented.

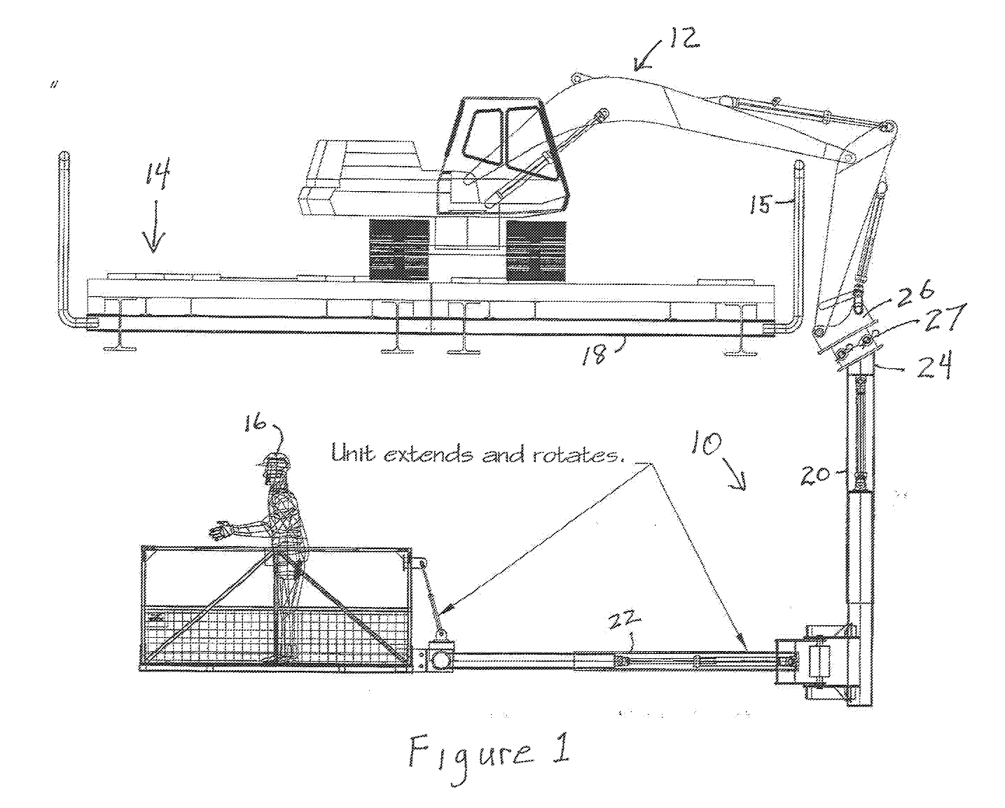

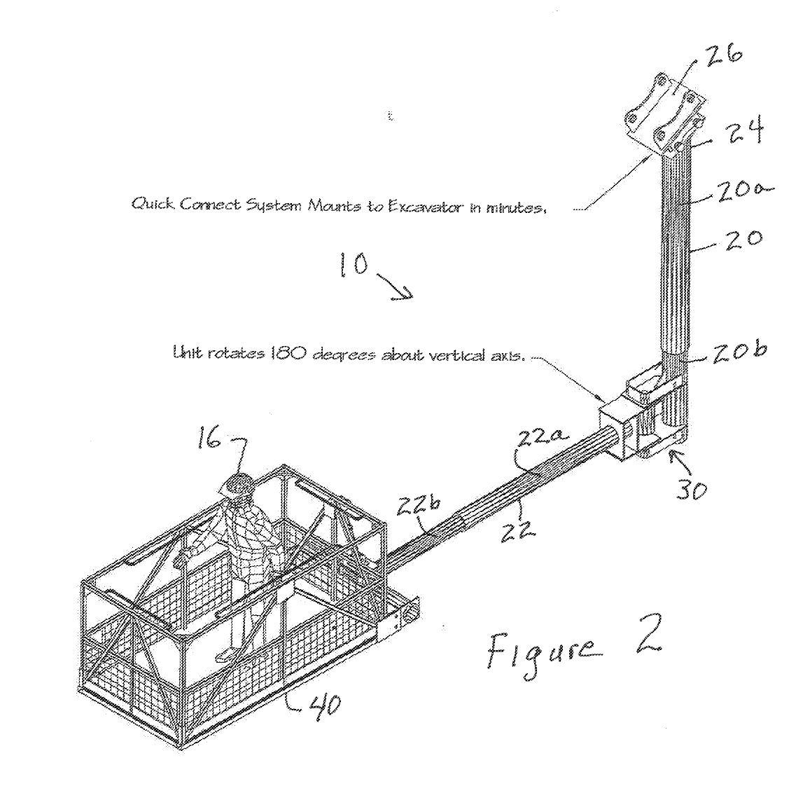

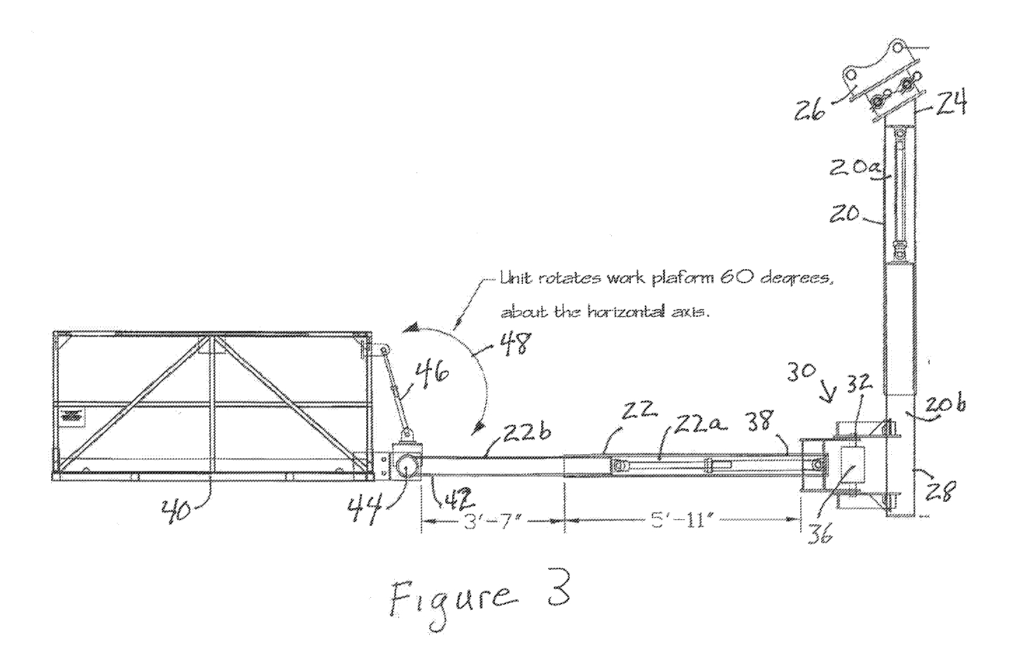

FIG. 1 shows a partially sectioned side view of an extension boom apparatus 10 attached to an excavator 12 located on bridge structure 14, as it might be used by an operator 16 to inspect the underside 18 of bridge structure 14. Extension boom apparatus 10 and excavator 12 are not drawn to the same scale. FIGS. 2-4 show different views of the same extension boom apparatus 10 and all views are intended for reference by the following disclosure unless otherwise referenced to a particular Figure.

Extension boom apparatus 10 includes a first extension boom 20 generally intended for vertical orientation and a second extension boom 22 generally intended for horizontal orientation. First extension boom 20 is connected at a proximal end 24 to excavator 12 via a leveraged connector 26. Leveraged connector 26 may include any suitable quick-connect mechanism 27, which may also be reversible, thereby enabling upward use of extension boom apparatus with respect to excavator 12.

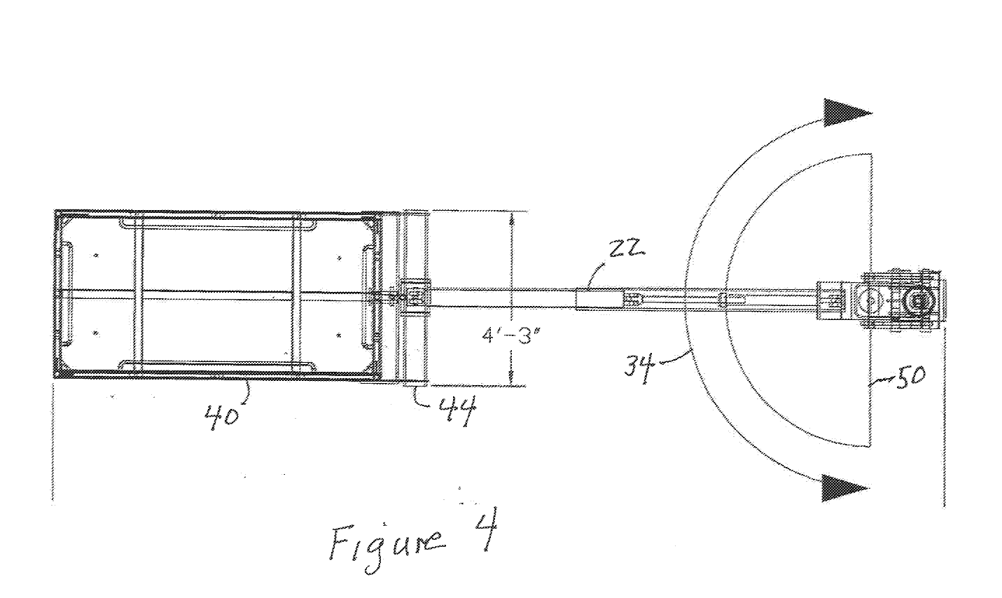

First extension boom 20 is connected at a distal end 28 to second extension boom 22 via an orthogonal connection 30. Which maintains a generally orthogonal relationship between first extension boom 20 and second extension boom 22. Connection 30 includes a rotational joint 32 oriented to enable the second extension boom 22 to rotate in a radial plane of the first extension boom 20. The scope of rotation 34 is intended to be approximately 180°, as shown in FIG. 4, wherein the radial plane of rotation is represented by the surface of the drawing. A motor 36 controls the positioning of second extension boom 22 within the range of rotation 34.

Second extension boom 22 is affixed to connection 30 at a proximal end 38, and a personnel basket 40 is rotatably connected to a distal end 42 of second extension boom 22 by a rotational joint 44. Joint 44 has a horizontal axis allowing the relative vertical rotation of personnel basket 40 with respect to second extension boom 22. Distal end 42 is farther connected to personnel basket 40 via a hydraulic actuator 46 which enables control of the angular orientation between basket 40 and extension boom 22 through an arc 48, which is approximately 60° about the horizontal orientation of personnel basket 40. Joint 44 and actuator 46 may alternatively be replaced by a vertical actuator (not shown) enabling the raising of personnel basket 44 with respect to second extension boom 22 thereby providing greater reach of the apparatus 10 around different types of bridge structures.

First and second extension booms 20 and 22 may be constructed in any suitable manner as used in the industry with hydraulic actuation. Booms 20 and 22 are intended to prevent rotation between their respective inner elements 20a, 22a and their respective inner elements 20b, 22b. Thus, they may have any suitable shape or cross section to prevent such rotation.

Any suitable personnel basket 40 may be used, such as elongated basket 40 or other industry available personnel buckets. Elongated basket 40 provides a degree of the movement to an operator 16 without requiring use of second extension boom 22. The elongation of basket 40 also allows operator 16 to be fully surrounded if desired and further enhances safety in the event that basket 40 is tilted to a vertical orientation.

In operation, excavator 12 is used for moving extension boom apparatus 10 from the surface of bridge structure 14 and over a side rail 15 most conveniently by rotation of second extension boom 22 with respect to first extension boom 20 using motor 36 to locate second extension boom 22 at an extreme end 50 (FIG. 4) of arc 34. This enables easy clearance of personnel basket 40 over side rail 15 and lowering of apparatus 10 by excavator 12. First extension boom 20 is then extended to lower personnel basket 40 of the underside 18 of bridge structure 14, and motor 36 then rotates second extension boom 20 and personnel basket 40 beneath bridge structure 14. First extension 20 may then be retracted to suitably position operator 16 with respect to the underside 18 of bridge structure 14. Second extension boom 22 and motor 36 are then used to position personnel basket 40 at any desired location within their range of motion. It may alternatively be necessary to move personnel basket and extension boom apparatus 10 over the side of and underneath a bridge structure without changing the angular position of second extension boom 22 with respect to first extension boom 20, depending upon structural limitations in the bridge structure. Leveraged connector 26 enables such movements of extension boom apparatus 10 as well as maintaining the general vertical orientation of first extension boom 20 during an access or inspection procedure. This alternative procedure is aided by controlling the angular position of basket 40 with actuator 46 to insure the safety of operator 16.

The present invention is illustratively described above in reference to the disclosed embodiments. Various modifications and changes may be made to the disclosed embodiments by persons skilled in the art without departing from the scope of the present invention as defined in the appended claims.

1. An extension boom apparatus for an excavator, comprising:
a first extension boom adapted for vertical orientation;
a second extension boom adapted for horizontal orientation;
a leveraged excavator coupling, affixed to a proximal end of the first extension boom;
an orthogonal attachment between a distal end of the first extension boom and a proximal end of the second extension boom; and
a personnel basket coupled to a distal end of the second extension boom.

2. The apparatus of claim 1, further comprising a rotational joint connecting the second extension boom to the orthogonal attachment and oriented to provide rotation of the second extension boom in a radial plane of rotation of the first extension boom.

3. The apparatus of claim 2, further comprising a mechanism for controlling rotation of the second extension boom in a radial plane of rotation of the first extension boom.

4. The apparatus of claim 1, farther comprising a rotational coupling between the second extension boom and the personnel basket, oriented to enable rotation of the personnel basket in a vertical axial plane of the second extension.

5. The apparatus of claim 4, further comprising an actuator for controlling the angular orientation between the personnel basket and the second extensional boom.
